(19) United States
(12) Patent Application Publication
(10) Pub. No.: US 2026/0085574 A1
(43) Pub. Date: Mar. 26, 2026

(54) Building Frame Flashing Insertion System

(71) Applicant: Anthony Prescott, Penn Valley, CA (US)

(72) Inventor: Anthony Prescott, Penn Valley, CA (US)

(21) Appl. No.: 19/293,039

(22) Filed: Aug. 7, 2025

Related U.S. Application Data
(60) Provisional application No. 63/698,008, filed on Sep. 23, 2024.

(51) Int. Cl. E06B 1/62

(52) U.S. Cl. CPC E06B 1/62; E06B 2001/628

(57) ABSTRACT

A window flashing insertion system for efficiently installing or retrofitting flashing around, for example, windows in structures with existing siding is disclosed. The system includes flexible, water-resistant flashing material to attach to a frame flange using fasteners, and features integrally formed, reinforced, and foldable pockets designed to slide between siding and framing without damage. An insertion tool is included, having a substantially L-shaped body with a longer first arm terminating in a wedge-shaped, notched edge and a shorter second arm with ergonomic grip recesses to enhance user control. The tool guides the flashing pockets into position securely and evenly. A method is also disclosed for using the tool and flashing material, involving positioning, aligning, inserting the flashing into the wall cavity, and securing it to the frame flange, thereby ensuring a durable and water-resistant window installation with minimal impact to existing siding.

### CROSS-REFERENCE TO RELATED APPLICATION

The present application claims priority to, and the benefit of, U.S. Provisional Application No. 63/698,088, which was filed on Sep. 24, 2024, and is incorporated herein by reference in its entirety.

### FIELD OF THE INVENTION

The present invention generally relates to building construction and window installation systems. More specifically, the present invention relates to a reusable, ergonomically designed window flashing insertion system configured to facilitate the installation of flashing material between the framing and siding of a building during new construction or window retrofitting. The invention comprises a roll of flexible, water-resistant flashing material having a proximal end adapted to be affixed to a frame flange (i.e., window or door flange) and a distal end including a series of integrally formed, reinforced, and foldable pockets designed for insertion into narrow structural cavities. The system further includes a specially designed insertion tool having a substantially L-shaped body with a wedge-shaped terminal edge for guiding the pockets into place, and an orthogonal ergonomic handle featuring contoured recesses to improve grip, leverage, and control during installation. Accordingly, the present disclosure makes specific reference thereto. Nonetheless, it is to be appreciated that aspects of the present invention are also equally applicable to other like applications, devices, and methods of manufacture.

### BACKGROUND

By way of background, in residential and light commercial construction, the installation or retrofitting of windows requires the use of flashing materials to provide a watertight seal between the window assembly and the surrounding structural components. Flashing is commonly inserted between the exterior siding and the underlying wall framing to direct water away from the building envelope and prevent infiltration that can cause rot, mold, or structural damage.

However, one of the persistent challenges encountered during window replacement or retrofitting projects is the insertion of new flashing material into the narrow space between the house framing and the siding. In many cases, the siding is fastened tightly against the structural studs adjacent to the window opening, leaving insufficient clearance to maneuver conventional flashing material into position. The limited space often requires excessive force to insert the flashing, which can result in the material bunching, folding, or tearing. Furthermore, once partially inserted, the flashing is difficult to reposition or guide uniformly, especially around corners or across variable wall geometries. This not only compromises installation efficiency but also increases the risk of water intrusion due to improper sealing or misalignment of the flashing. Accordingly, individuals desire an improved system and method for installing flashing material that overcomes the limitations of conventional systems and methods.

Therefore, there exists a long-felt need in the art for an improved window flashing installation system that enables users to effectively insert flashing material between the framing and siding of a building. There is a long-felt need for a system that enables flashing to be retrofitted in limited-clearance conditions, such as where siding is fastened tightly to studs adjacent to window openings. Additionally, there is a long-felt need for a flashing device that enables smooth maneuverability along the framing structure. Furthermore, there is a long-felt need for a tool that provides installers with ergonomic control and precision, thereby reducing installation time and ensuring a watertight seal. Finally, there is a long-felt need for a system that improves the overall efficiency and reliability of window retrofitting without requiring extensive removal or modification of exterior siding.

The subject matter disclosed and claimed herein, in one embodiment, comprises a window flashing insertion system including a roll of flexible, water-resistant flashing material for attachment to a frame flange (i.e., window or door flange) and incorporates a plurality of integrally formed, reinforced, and foldable pockets. The pockets are dimensioned to extend laterally from the flashing and are specifically constructed to be inserted into the narrow gap between the building's framing and siding. The system further includes a flashing insertion tool having a substantially L-shaped body with a first arm and a second orthogonal arm. The first arm features a beveled terminal edge and integrated pivot notched arms designed to guide and press the pockets into position behind the siding. The second arm includes an ergonomic grip section with contoured finger recesses, providing enhanced control and comfort during use.

In one embodiment, the flashing material is composed of reinforced nylon webbing with embedded polymeric strands to increase flexibility and tear resistance. The pockets may be pre-creased along fold lines to enable compact packaging and facilitate expansion during deployment.

In this manner, the frame (i.e., window frame) flashing insertion system of the present invention addresses long-standing challenges associated with conventional flashing installation, particularly in retrofit scenarios with constrained access. The system enables flashing to be inserted efficiently and precisely into tight structural gaps without distortion or damage. The reinforced pockets maintain their shape during installation, improving alignment and sealing performance. The specialized insertion tool offers a high degree of user control, minimizing errors and physical strain. The system reduces labor time, preserves the integrity of existing siding, and improves the quality and longevity of window installations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a frame (i.e., window frame) flashing insertion system that facilitates the efficient and damage-free installation or retrofitting of window flashing in residential and commercial structures. The system includes a roll of flexible, water-resistant flashing material having a proximal end configured to attach to a frame flange (i.e., window or door flange), preferably using an adhesive layer. The distal end of the flashing includes multiple integrally formed, reinforced, and foldable pockets that extend laterally from the top edge of the material. These pockets are specifically dimensioned to be inserted between the building's siding and framing without tearing or deforming the material. A specially designed insertion tool is also included, featuring a substantially L-shaped body with a first arm and an orthogonal second arm. The first arm includes a beveled or wedge-shaped terminal edge with pivot notched arms that facilitate smooth insertion, while the second arm incorporates ergonomic grip recesses to enhance user control and comfort during use.

In another embodiment, a method for installing window flashing using the window flashing insertion system is described. The method begins by removing an existing window from a structure, followed by measuring and cutting the appropriate length of flashing material. The flashing is positioned so that the reinforced pockets align with the cavity between the siding and the framing. Using the insertion tool, with its L-shaped body, beveled edge, and ergonomic grip, the pockets are pushed into the cavity without displacing the siding. Once in place, the proximal end of the flashing is secured to the frame flange (i.e., window or door flange) using adhesive, fasteners, or thermal bonding for a watertight and durable seal around the window opening.

In one embodiment, the insertion tool comprises a substantially L-shaped body formed from a first arm and a second arm. The first arm includes a wedge-shaped terminal edge with two pivot notched arms to interface with flashing pockets and wall surfaces. The second arm serves as a handle and features an ergonomic gripping member with contoured recesses to comfortably accommodate human fingers. This tool is engineered to guide the flashing into the cavity between the siding and framing, maintaining the structural integrity of both the flashing and the wall components during installation.

In another embodiment, the reinforced pockets are pre-creased along fold lines to facilitate folding during packaging and unfolding during installation.

In still another embodiment, the flashing material includes a thermally activated adhesive on at least one surface to improve bonding to the frame flange (i.e., window or door flange) or wall substrate upon application of heat or pressure.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of window flashing insertion system of the present invention in accordance with the disclosed structure;

FIG. 2 illustrates a perspective view depicting the window flashing insertion system in operational use within a residential structure during a window retrofitting process in accordance with one embodiment of the present invention;

FIG. 3 illustrates a flow chart depicting steps in using the system of the present invention for installing a flashing in accordance with the disclosed structure; and

FIG. 4 illustrates a perspective view showing the flashing being installed on a frame flange (i.e., window or door flange) using the insertion tool in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved window flashing installation system that enables users to effectively insert flashing material between the framing and siding of a building. There is a long-felt need for a system that enables flashing to be retrofitted in limited-clearance conditions, such as where siding is fastened tightly to studs adjacent to window openings. Additionally, there is a long-felt need for a flashing device that enables smooth maneuverability along the framing structure. Furthermore, there is a long-felt need for a tool that provides installers with ergonomic control and precision, thereby reducing installation time and ensuring a watertight seal. Finally, there is a long-felt need for a system that improves the overall efficiency and reliability of window retrofitting without requiring extensive removal or modification of exterior siding.

The present invention, in one exemplary embodiment, is a method for installing window flashing using the window flashing insertion system. The method begins by removing an existing window from a structure, followed by measuring and cutting the appropriate length of flashing material. The flashing is positioned so that the reinforced pockets align with the cavity between the siding and the framing. Using the insertion tool, with its L-shaped body, beveled edge, and ergonomic grip, the pockets are pushed into the cavity without displacing the siding. Once in place, the proximal end of the flashing is secured to the frame flange (i.e., window or door flange) using adhesive, fasteners, or thermal bonding, for a watertight and durable seal around the window opening.

Reference will now be made in detail to the present preferred embodiments of the invention, examples of which are illustrated in the accompanying drawings. Wherever possible, the same reference numerals are used in the drawings and the description to refer to the same or like parts.

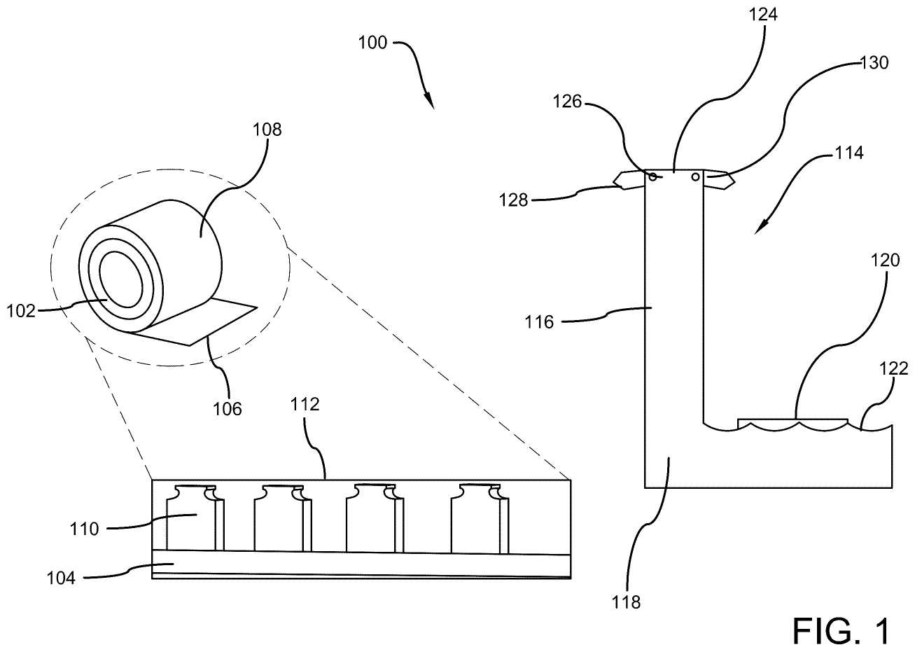

Referring initially to the drawings, FIG. 1 illustrates a perspective view of frame (i.e., window frame) flashing insertion system of the present invention in accordance with the disclosed structure. The frame (i.e., window frame) flashing insertion system or kit 100 of the present invention is designed to streamline the installation or retrofitting of windows or doors in residential buildings. The window flashing insertion system or kit 100 can be used in both new buildings and renovations, especially where siding of a building is difficult to remove or is delicate in construction. The window flashing insertion system or kit 100 includes a flashing material roll 102. The flashing material roll 102 includes a flashing material 104 in the form of a flexible, water-resistant webbing. The flashing material 104 has a proximal end 106 which is adapted to affix to a frame flange (i.e., window or door flange). The proximal end 106 preferably has an adhesive layer or side 108 to affix to the frame flange (i.e., window or door flange). In some embodiments, mechanical fasteners such as screws can be used for affixing the flashing material 104.

The flashing material 104 includes a plurality of integrally formed, reinforced, and foldable pockets 110. Each pocket of the foldable pockets 110 extends laterally from the top edge 112 of the flashing material 104 and has a depth (“D”) of approximately 1 to 5 inches and a width (“W”) of approximately 2 to 5 inches. In one embodiment, each pocket of the foldable pockets 110 extends laterally from the top edge 112 of the flashing material 104 and has a depth (“D”) of approximately 2 to 4 inches and a width (“W”) of approximately 3 to 4 inches. It should be noted that the pockets are dimensioned and constructed to be insertable between the framing and siding of the building without deformation or tearing of the flashing material 104. In one embodiment, the flashing material 104 comprises nylon webbing reinforced with polymeric strands to provide enhanced tear resistance and flexibility. The reinforced pockets can be pre-creased along fold lines to facilitate folding during packaging and unfolding during installation.

The system 100 includes a flashing insertion tool 114 which is configured to guide and insert the reinforced pockets of the flashing 104 into a narrow space between siding and framing. As illustrated, the flashing insertion tool 114 is substantially L-shaped and has a first arm 116 and an orthogonal second arm 118. In the preferred embodiment, the first arm 116 is longer than the second arm 118.

An ergonomic gripping member 120 is positioned on the second arm 118 and includes one or more ergonomically contoured grip recesses 122 to accommodate human fingers to enhance control and comfort during insertion of the flashing using the flashing insertion tool 114. The first arm 116 has a beveled or wedge-shaped terminal edge 124 at the distal end 126 thereof. The terminal edge 124 includes a first pivot notched arm 128 and a second pivot notched arm 130 to enable sliding engagement between flashing pockets and the surface of the building structure, as illustrated later in the disclosure.

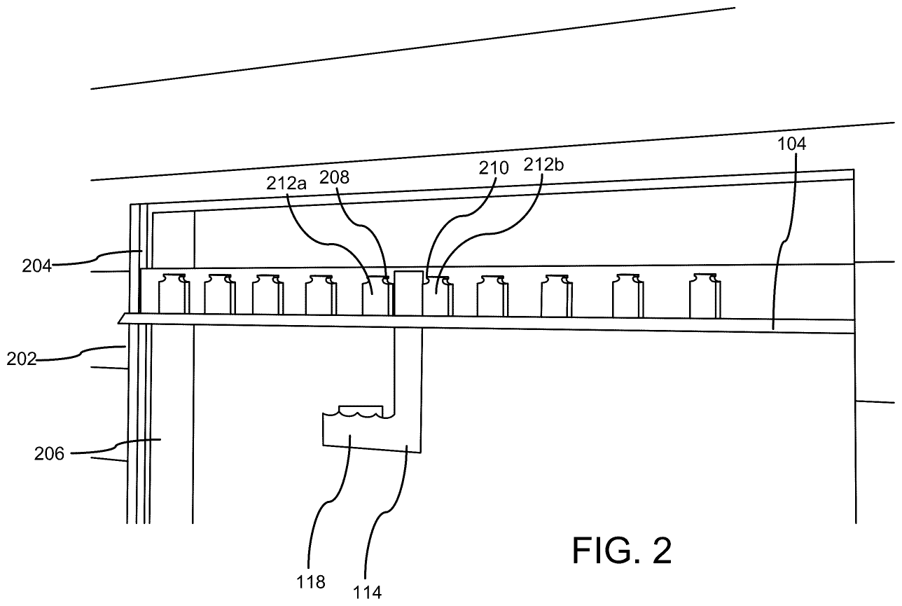

FIG. 2 illustrates a perspective view depicting the window flashing insertion system in operational use within a residential structure during a window retrofitting process in accordance with one embodiment of the present invention. As illustrated, an external siding 202 includes a horizontal cavity 204 in which the flashing installation is performed using the system 100. The flashing material 104 is positioned in alignment with the cavity 204 and is inserted between the siding 202 and the framing 206.

The flashing insertion tool 114 is positioned in alignment with the flashing material 104 such that the pivot notched arms 128, 130 are engaged with the cavities 208, 210 of the adjacent pockets 212a, 212b, respectively. The flashing 104 is pushed uniformly by holding the insertion tool 114 using the second arm 118. It should be noted that flashing remains accessible to be adhered or fastened to the frame flange (i.e., window or door flange) (not shown).

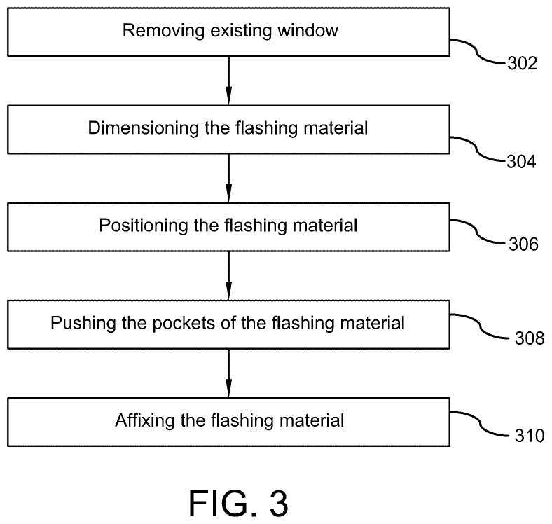

FIG. 3 illustrates a flow chart depicting steps in using the system of the present invention for installing a flashing in accordance with the disclosed structure. For retrofitting a window, initially, the existing window is removed (Step 302). Then, the flashing material is measured and cut to desired length for installation for the window (Step 304). Thereafter, the flashing material is positioned at desired position such that the pockets and proximal end of the flashing remain accessible to an operator (Step 306). Then, the first arm of the insertion tool is aligned with the pockets, and using the gripping recess of the second arm, the pockets are pushed into the cavity between the siding and the frame (Step 308). Finally, the flashing is affixed to a frame flange (i.e., window or door flange) using adhesive backing, fasteners, or thermal bonding (Step 310).

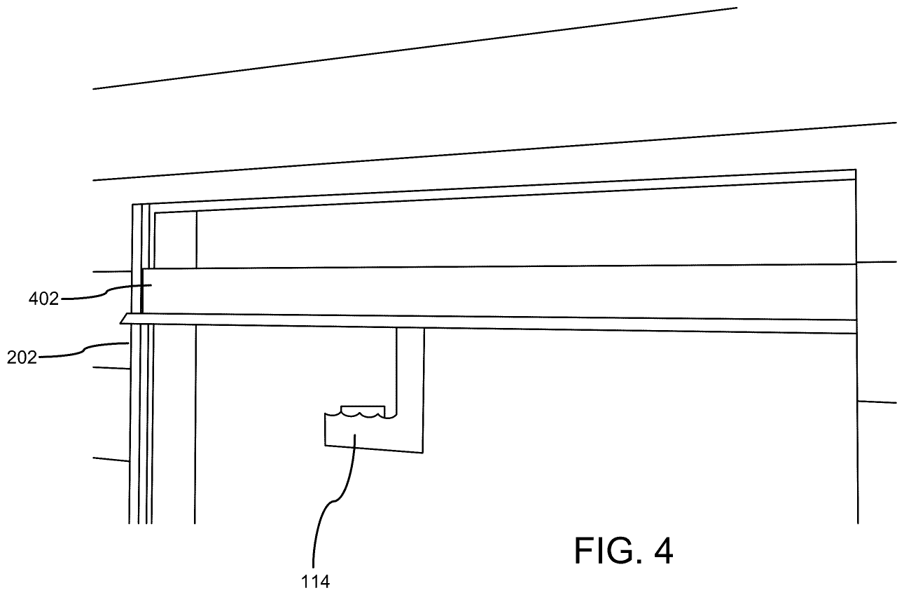

FIG. 4 illustrates a perspective view showing the flashing being installed on a frame flange (i.e., window or door flange) using the insertion tool in accordance with the disclosed structure. As illustrated, the flashing 104 is installed along the frame flange (i.e., window or door flange) 402. The L-shaped insertion tool 114 is in a resting position beneath the siding 202 and can remain engaged with the pockets of the flashing 104.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “window flashing insertion system”, “window flashing system”, and “system” are interchangeable and refer to the window flashing insertion system or kit 100 of the present invention.

Notwithstanding the foregoing, the window flashing insertion system or kit 100 of the present invention can be of any suitable configuration as is known in the art without affecting the overall concept of the invention, provided that it accomplishes the above-stated objectives. One of ordinary skill in the art will appreciate that the window flashing insertion system or kit 100 as shown in the FIGS. are for illustrative purposes only, and that many other configurations of the window flashing insertion system or kit 100 are well within the scope of the present disclosure. Although the dimensions of the window flashing insertion system or kit 100 are important design parameters for user convenience, the window flashing insertion system or kit 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A frame flashing insertion system comprising:
a flashing material and a flashing material insertion tool;
wherein said flashing material having a flexible and water-resistant webbing material;
wherein said flashing material having a proximal end affixable to a frame flange;
wherein said proximal end having an adhesive layer for affixing to said frame flange;
wherein said flashing material having a plurality of integrally formed and foldable pockets; and
further wherein said flashing material insertion tool having an L-shape including a first arm and a second arm orthogonal to said first arm to guide and insert said plurality of integrally formed and foldable pockets of said flashing material into a space between siding and framing of a building structure.

2. The frame flashing insertion system of claim 1, wherein said first arm having a first length and said second arm having a second length, further wherein said first length is greater than said second length.

3. The frame flashing insertion system of claim 2, wherein each pocket of said plurality of integrally formed and foldable pockets extending laterally from a top edge of said flashing material.

4. The frame flashing insertion system of claim 3, wherein said each pocket of said plurality of integrally formed and foldable pockets having a depth from 1 inch to 5 inches and a width from 2 inches to 5 inches.

5. The frame flashing insertion system of claim 3, wherein said each pocket of said plurality of integrally formed and foldable pockets having a depth from 2 inches to 4 inches and a width from 3 inches to 4 inches.

6. The frame flashing insertion system of claim 3, wherein said flashing material in a roll of flashing material.

7. The frame flashing insertion system of claim 1, wherein said webbing material is a nylon webbing reinforced with polymeric strands.

8. The frame flashing insertion system of claim 1, wherein said each pocket of said plurality of integrally formed and foldable pockets pre-creased along fold lines to facilitate folding during packaging and unfolding during installation.

9. The frame flashing insertion system of claim 1, wherein said second arm having an ergonomic gripping member including at least two contoured grip recesses to accommodate human fingers therein.

10. The frame flashing insertion system of claim 9, wherein said first arm having a beveled terminal edge at a distal end of said first arm.

11. The frame flashing insertion system of claim 10, wherein said beveled terminal edge having a first pivot notched arm and a second pivot notched arm to enable sliding engagement between said plurality of integrally formed and foldable pockets and the building structure.

12. The frame flashing insertion system of claim 11, wherein said flashing material is a window flashing material and said frame flange is a window frame flange.

13. A frame flashing insertion kit comprising:
a kit comprising a flashing material and a flashing material insertion tool;
wherein said flashing material having a flexible and water-resistant webbing material;
wherein said flashing material having a proximal end affixable to a frame flange;
wherein said proximal end having an adhesive layer for affixing to said frame flange;
wherein said flashing material having a plurality of integrally formed and foldable pockets;
wherein said flashing material insertion tool having an L-shape including a first arm and a second arm orthogonal to said first arm to guide and insert said plurality of integrally formed and foldable pockets of said flashing material into a space between siding and framing of a building structure;
wherein each pocket of said plurality of integrally formed and foldable pockets extending laterally from a top edge of said flashing material; and
further wherein said each pocket of said plurality of integrally formed and foldable pockets having a depth from 1 inch to 5 inches and a width from 2 inches to 5 inches.

14. The frame flashing insertion system of claim 13, wherein said second arm having an ergonomic gripping member including at least two contoured grip recesses to accommodate human fingers therein.

15. The frame flashing insertion system of claim 14, wherein said first arm having a beveled terminal edge at a distal end of said first arm.

16. The frame flashing insertion system of claim 15, wherein said beveled terminal edge having a first pivot notched arm and a second pivot notched arm to enable sliding engagement between said plurality of integrally formed and foldable pockets and the building structure.

17. The frame flashing insertion system of claim 16, wherein said flashing material is a window flashing material and said frame flange is a window frame flange.

18. A method of inserting flashing into a frame, the method comprising the steps of:
providing a kit comprising a flashing material and a flashing material insertion tool, wherein said flashing material having a flexible and water-resistant webbing material, wherein said flashing material having a proximal end affixable to a frame flange, wherein said flashing material having a plurality of integrally formed and foldable pockets;
affixing said flashing material to said frame flange;
guiding and inserting said plurality of integrally formed and foldable pockets of said flashing material with said flashing material insertion tool into a space between siding and framing of a building structure, wherein said flashing material insertion tool having an L-shape including a first arm and a second arm orthogonal to said first arm; wherein each pocket of said plurality of integrally formed and foldable pockets extending laterally from a top edge of said flashing material; wherein said first arm having a beveled terminal edge at a distal end of said first arm, wherein said beveled terminal edge having a first pivot notched arm and a second pivot notched arm to enable sliding engagement between said plurality of integrally formed and foldable pockets and the building structure;
aligning said flashing material insertion tool with said flashing material, wherein said first pivot notched arm engaged with a first cavity of a first foldable pocket and said second pivot notched arm engaged with a second cavity of a second foldable pocket, wherein said first foldable pocket is adjacent to said second foldable pocket; and
pushing at least said first foldable pocket and said second foldable pocket into the space between siding and framing of the building structure.

19. The method of inserting flashing into a frame of claim 18, wherein said second arm having an ergonomic gripping member including at least two contoured grip recesses to accommodate human fingers therein.

20. The method of inserting flashing into a frame of claim 19, wherein said flashing material is a window flashing material and said frame flange is a window frame flange.
